(19) United States
(12) Patent Application Publication
(10) Pub. No.: US 2003/0031551 A1
(43) Pub. Date: Feb. 13, 2003

(54) Apparatus for and method of transporting and stacking a predetermined number of groups of flat articles and moving the group stack to a remote location

(76) Inventor: Roger S. Williams, New Richmond, OH (US)

Correspondence Address: Charles Y. Lackey, P.O. Box 5871, Winston-Salem, NC, 27113-5871, US

(21) Appl. No.: 09/928,269

(22) Filed: Aug. 13, 2001

(51) Int. Cl. B65G 57/16

(52) U.S. Cl. 414/790.6; 414/907; 53/540

(57) ABSTRACT

A plurality of flat substantially similar articles such as meat patties which have been formed from an elongated cylindrical stuffed casing are deposited onto a conveyor and then advanced in a co-planer relationship to an accumulator station and a series of lifting stages where predetermined numbers of articles are divided into individual groups and each group of articles is moved onto a carrier member and advanced one at a time to a stacking station. There the articles of each succeeding group are deposited onto the articles of each preceding group until a predetermined number of groups of articles have been vertically stacked after which the entire stack is released onto a conveyor for further processing. The lifting stations prevent the articles from being pressed together or shingling one on top the other thereby avoiding article damage during processing.

### BACKGROUND OF THE INVENTION

1. Field of the Invention

The present invention is directed to an apparatus for and a method of loading groups of flat articles such as meat patties in a suitable receptacle wherein a predetermined number of groups of articles are sequentially accumulated, deposited on individual carrier members, stacked and thereafter discharged in a stack formation onto a conveyor on which they are supported prior to being housed within a receptacle.

2. Description of the Prior Art

The standard apparatus for accumulating, stacking and packaging meat patties is disclosed in U. S. Pat. No. 4,236,855 issued Dec. 2, 1980, the contents of which are incorporated herein by reference. This machine has been used for a considerable period of time in the industry and has functioned adequately, however there are some features of the machine that have a tendency to restrict its output because of product distortion occurring when increased speeds are utilized. This machine is also limited by the use of conventional conveyors that cannot be instantaneously started or stopped or move products in more than one direction. Thus there is a pronounced need for an improved machine to overcome these deficiencies, and it is to that need that the present invention is directed.

### SUMMARY OF THE INVENTION

The present invention is directed to an apparatus and method that continuously accumulates a plurality of substantially similarly sized preformed flat articles like meat patties where individual patties are advanced in an end-to-end abutting relationship to one or more lifting stations each of which is selectively operable to elevate a predetermined number of articles away from the moving conveyor and hold these articles in a stationary position until a desired occurrence takes place. Elevating a predetermined number of patties at lifting stations reduces pressure on the products and enables the formation of the articles into individual and separated groups of articles which are eventually positioned at an accumulator station and thereafter advanced to an elevator station. There they are lowered, group-by-group, so that each successive carrier member containing a similar group of articles is deposited onto the upper surfaces of the articles of a preceding group until a predetermined number of groups each containing the same number of articles have been stacked one on top of another. A predetermined number of article groups (15-20 groups for example) are accumulated. The entire stack of article groups is then deposited on an endless conveyor and advanced to a station where an operator lowers a container such as a cardboard box over and onto the stack of articles thereby filling the box.

The operating speed of the invention is significantly greater than that of its mechanical predecessor because of the use of servo motors in all movement sensitive locations. These servo motors can be operated to instantaneously stop, start or reverse direction of a conveyor or moving carrier. Additional machine operating speed and efficiency is achieved by use of a transversing belt or shuttle which first receives a group of articles on a carrier member, moves to an elevator station and thereafter instantaneously withdraws to permit the group and carrier member to nest upon the previously deposited group and carrier member.

The primary objective of the present invention is to provide an apparatus for and a method of bulk loading a substantially continuous supply of flat and/or circular articles wherein each individual article has been severed from an elongated member, a predetermined number of articles has been formed into groups, and the groups are stacked and packaged in a rapid and efficient manner heretofore unachieved in the art without damage or distortion to the products being processed.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention, which is measured by its claims, nor to limit its scope in any way.

Thus, the objects of the invention set forth above, along with the various features of novelty which characterize the invention, are noted with particularity in the claims annexed to and forming a part of this disclosure. For a better understanding of the invention, its operating advantages and the specific results obtained by its use, reference should be made to the following detailed specification taken in conjunction with the accompanying drawings wherein like characters of reference designate like parts throughout the several views.

The drawings are included to provide a further understanding of the invention and are incorporated in and constitute a part of this specification. They illustrate embodiments of the invention and, together with their description, serve to explain the principles of the invention.

### BRIEF DESCRIPTION OF THE DRAWINGS

FIG. 1 is a side elevational view of the stacking machine of the present invention;

FIG. 2 is a top plan view of the stacking apparatus shown in FIG. 1;

FIG. 3 is a side elevational and fragmentary view of the front or beginning end of the apparatus shown in FIGS. 1 and 2;

FIG. 4 is side elevational, enlarged and fragmentary view of the third lifting stage of the machine comprising the present invention;

FIG. 5 is an end elevational and schematic view of the second and third lifting stations wherein the meat products have been raised away from the conveyor and are being held in stationary condition;

FIG. 6 is an end elevational and schematic view of the third or final lifting station wherein products have been raised and are disengaged from the conveyor belt and thus held in a stationary condition;

FIG. 7 is a side elevational and schematic view of the product release station cooperatively associated with the elevator assembly of the present invention;

FIG. 8 is a side elevational view of the elevator assembly shown in FIG. 7;

FIG. 9 is an end elevational view of the elevator assembly shown in FIG. 8 illustrating the positioning of the traversing belt in the group and carrier member receiving position;

FIG. 10 is a side elevational and schematic view of the elevator assembly wherein a receptive platform or elevator A is in a position to receive a first group and carrier member;

FIG. 11 is a side elevational and schematic view of platform A in a position to receive additional carrier members and article groups incrementally;

FIG. 12 is a side elevational and schematic view of carrier member receptive platform A ready to be quickly moved a beginning position to receive;

FIG. 13 is a side elevational and schematic view of the elevator assembly with platform A moved upwardly and with platform B being quickly positioned to receive a first group and carrier member;

FIG. 14 is a side elevational and schematic view of the first lifting stage showing the stop mechanism and the release mechanism; and

FIG. 15 is a plan view of the components shown in FIG. 14.

### DESCRIPTION OF THE PREFERRED EMBODIMENT

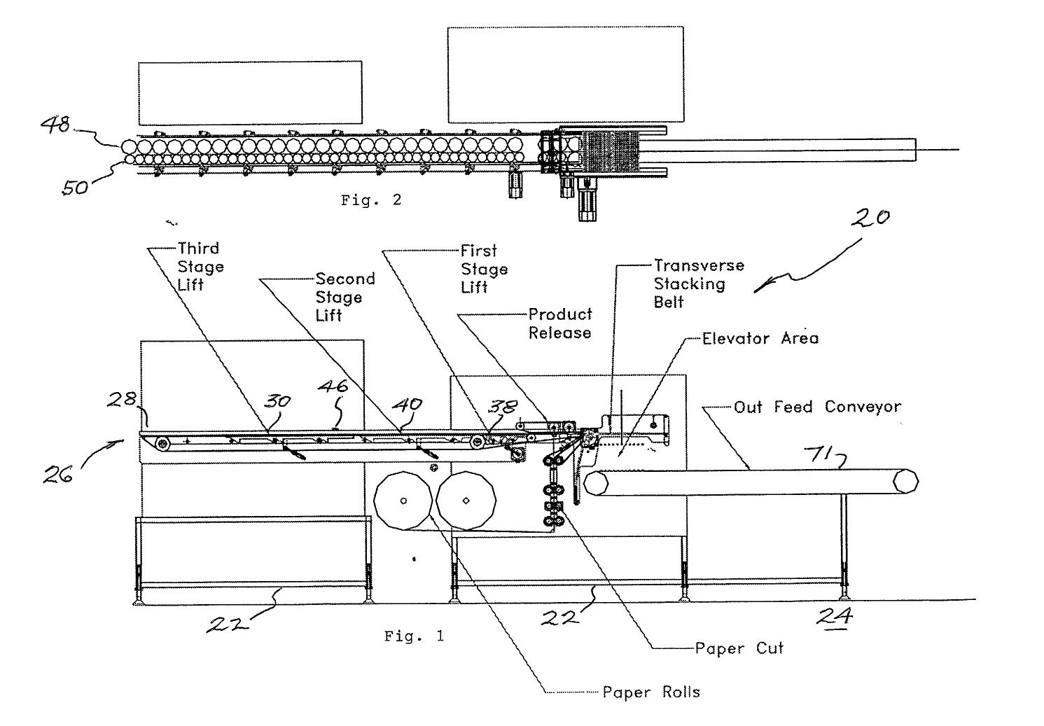

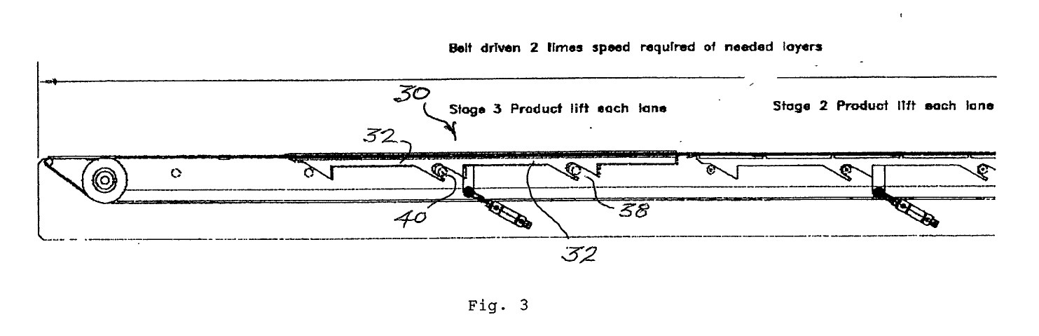

Referring now to the drawings and particularly to FIG. 1, the apparatus for sequentially transporting, accumulating and stacking a predetermined number of groups of individual flat articles generally designated 20 has a frame 22 supporting the components subsequently to be described at a predetermined location above floor 24. The front loading end of machine 20 shown generally as 26 is fed by a conventional slicer of the type which includes rotating blades adapted to continuously sever a plurality of slices from an elongated substantially cylindrical package such as sausage or hamburger patties. Since the slicer mechanism is of conventional construction, it is not shown, it being understood that such devices are commercially available for use in the meat packing industry.

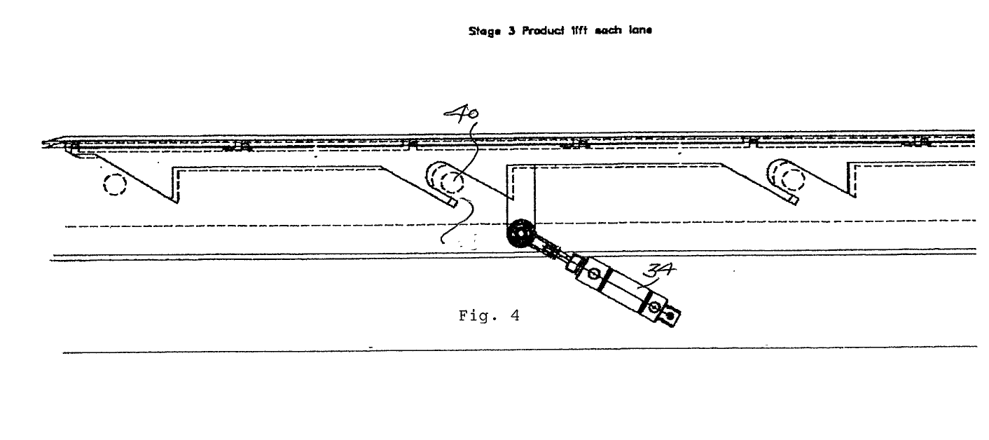

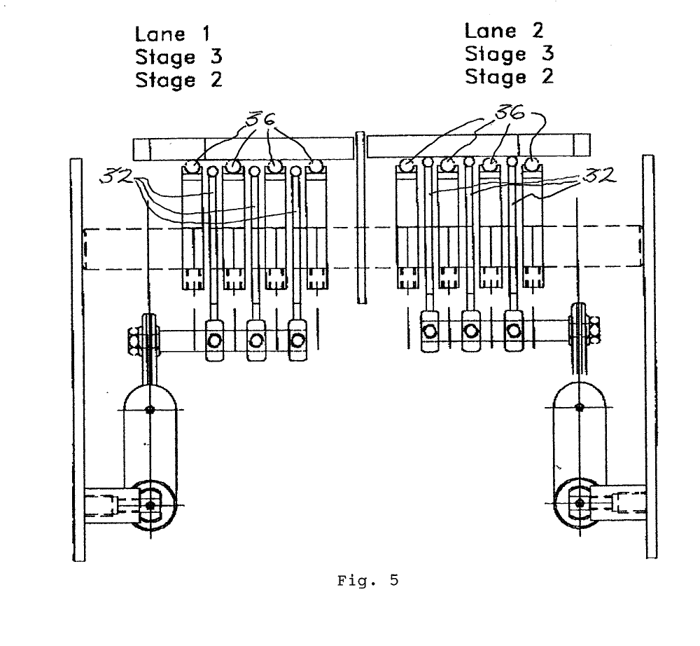

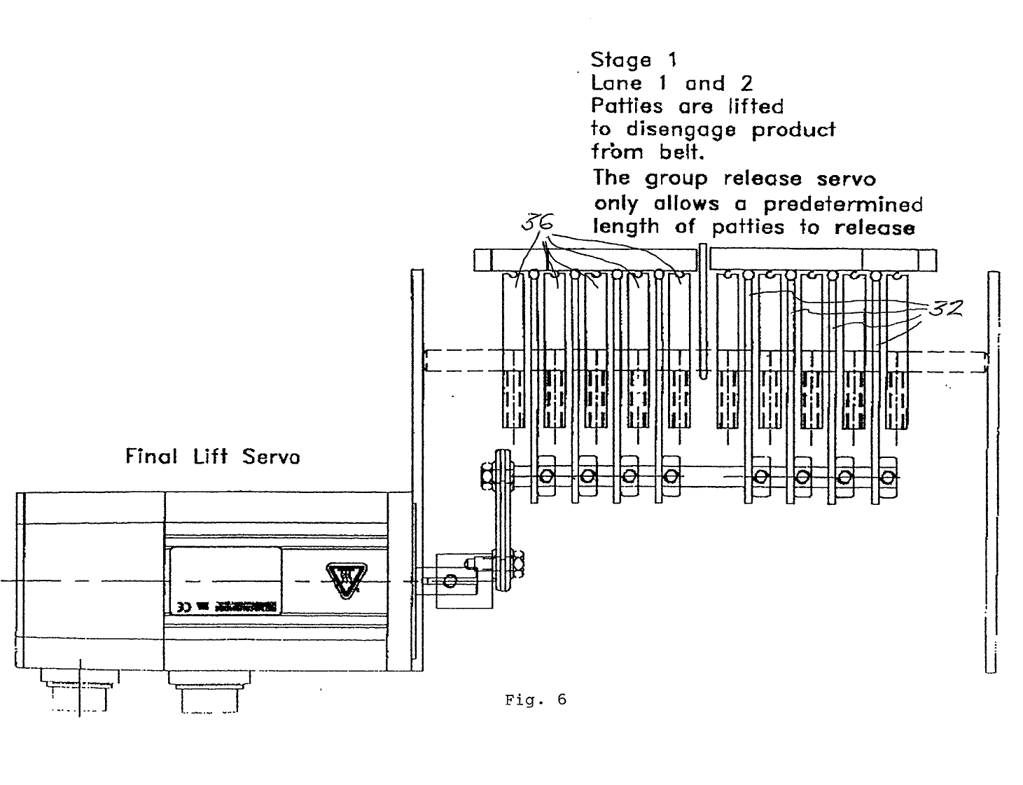

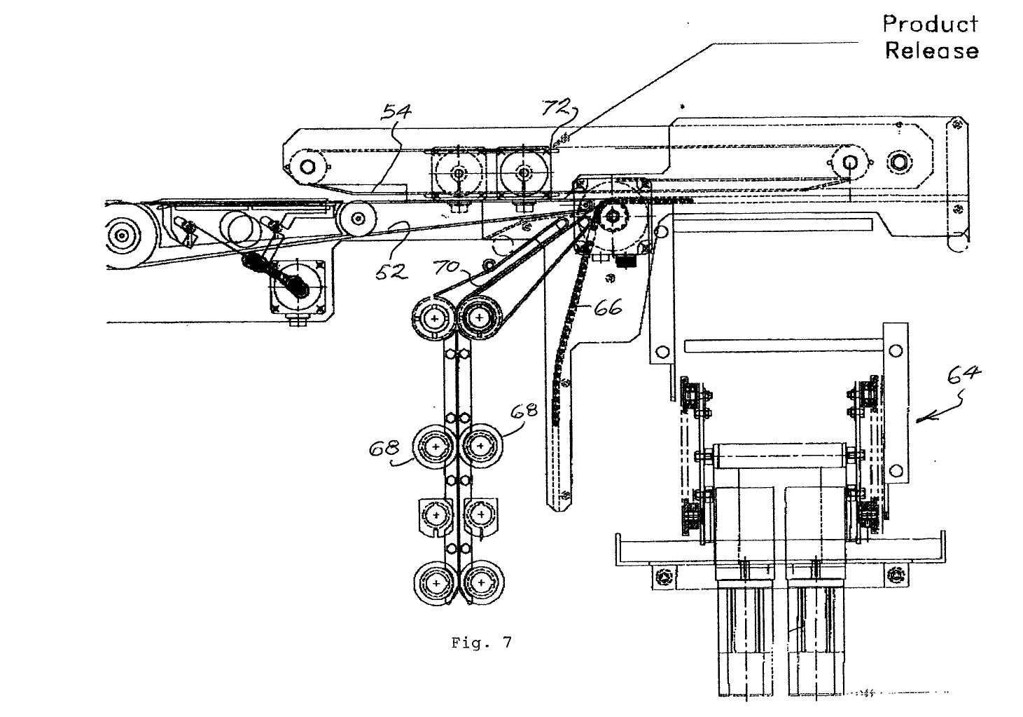

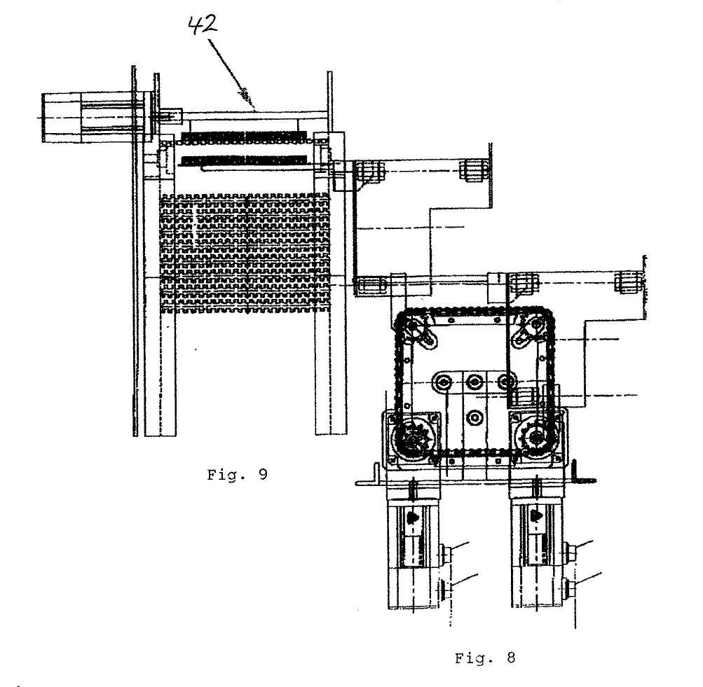

An accumulating and advancing section of the machine is shown generally as 28 and includes a third lifting stage 30, the details of which are shown in FIGS. 3, 4 and 5. Lifting stage 30 has a plurality of rails 32 (FIG. 3) that are slidably displaceable by appropriate displacing means such as air or fluid cylinders 34. Rails 32 are positioned between a number of conveyor strands 36 (FIG. 5) and movable with respect thereto to form third lifting stage 30 and have slots 41 cooperating with lugs 40 that raise rails 32 and lifting stage 30 formed thereby between conveyor strands 36 to hold a number of articles or products in a raised and stationary condition.

The lifting stages prevents products from shingling one on top of the other and avoids product distortion because of pressure. The number of products one behind the other and a temperature rise caused by friction builds pressure resulting in product damage or distortion. Thus the lifting stages control the driving force of the products to avoid disturbing harmony of pattern grouping.

First lifting stage 38 lifts products to separate for group patterns in conjunction with the product stop/release mechanism 42. Second lifting stage 40 and third lifting stage 30 lift at the same time to keep pressure off first lifting stage 38. If products are traveling from left to right, the stop/release mechanism 42 is located to the right of first lifting stage 38. The distance between stop/release mechanism 42 and lifting stage 38 is determined by the amount of product required for one group or layer. When stop/release mechanism 42 releases with the second and third lifting stage 40, 30 in an up position, a group from first lifting stage 38 is moved to shuttle 44 and thus separates from first lifting stage 38. This separation will allow stop/release mechanism 42 to return to the stop position to receive the next group. First lifting stage 38 then lowers to allow a small group of products to move to the stop area. Once stop/release mechanism 42 is confirmed in the stop position, the second and first lifting stages 40, 38 can lower. The gap or separation created will collapse with the next cycle.

Third lifting stage 30 has two independent lane lifts that are controlled by a sensor 46 in each lane 48, 50. When a missing product is sensed by a sensor, lifting stage 30 (rails 36) lowers and products are engaged by conveyor strands 36 to move products into the sensed empty product spaces. The need to supply both lanes with the required amount of products normally averages out with a rate of rejected products. The need to instantly maintain balance requires the first lane portion of third lifting stage 30 to lower out of a normal cycle. This occurs when the normal reject rate increases in one lane or the other. If the lane sensor or lane sensors call for product over an amount of time that effects normal operation of the machine, the machine will go to a cycle stop position. This is because a fixed distance of product is required to operate in a normal condition. In the cycle stop mode, first and second lifting stages 38, 40 are up and stop/release mechanism 42 is in the stop position. Third lifting stage 30 is up or down depending upon the sensors. The machine will start and cycle normally once all lanes are satisfied with required products continuously supplied by the slicing machine. Conveyor strands 36 run continuously in the cycle stop mode.

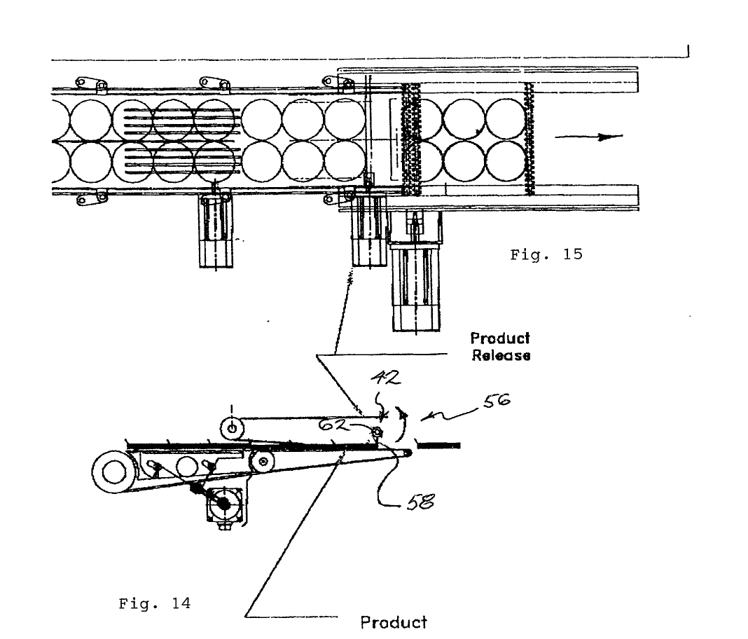

From first lifting stage 38, groups of products move to a conveyor 52 positioned under a cooperating belt 54 which engages and drives the product groups horizontally to the product stop/release station shown generally as 56. Belt 54 can be slowed to make certain that products are not dislodged or move upon arrival at product stop/release station 56. Station 56 includes a rotatable paddle wheel 58 with a single paddle 60 affixed to a supporting hub 62 which make up stop/release mechanism 42. Paddle 60 serves as a stop mechanism 42 when a group moving on conveyer 52 encounters it in the stop or down position as shown in FIG. 14. Movement of the group ceases until the elevator assembly shown generally as 64 and shuttle 66 are ready to receive it. At that time paddle 60 releases the group and is rotated 360 degrees and at a speed to reach another stop position precisely in the middle of the separation or gap between groups discussed earlier. This operation is a continuous one so long as the apparatus continues to run.

Shuttle 66 is a multi-hinged rectangular preferably plastic slat component capable of rapid reciprocatory movement from a group pickup location to the elevator assembly 64. It is servo motor driven and replaces the ram used in the earlier mechanical machine.

Rolls of paper 68 are mounted on frame 22 as shown in FIG. 1, and a web 70 from one roll is fed upwardly and then somewhat horizontally through driving and cutting elements to cut the web into sheets, each of which forms a carrier member of a preselected size. The sheets then move to the product release area 72 where a single sheet is placed over shuttle 66 just before it is moved horizontally to elevator assembly 64. An article group is discharged onto a sheet with the group of products covering the entire sheet, and the group and sheet are then moved directly to a first platform A of elevator assembly 64. As shuttle 66 and the carried sheet and group reach the appropriate position over platform A, shuttle 66 is quickly withdrawn by the action of a servo motor and the sheet and carried group slide off and nest on platform A either as a first entry or on top of previously positioned similar sheets and groups.

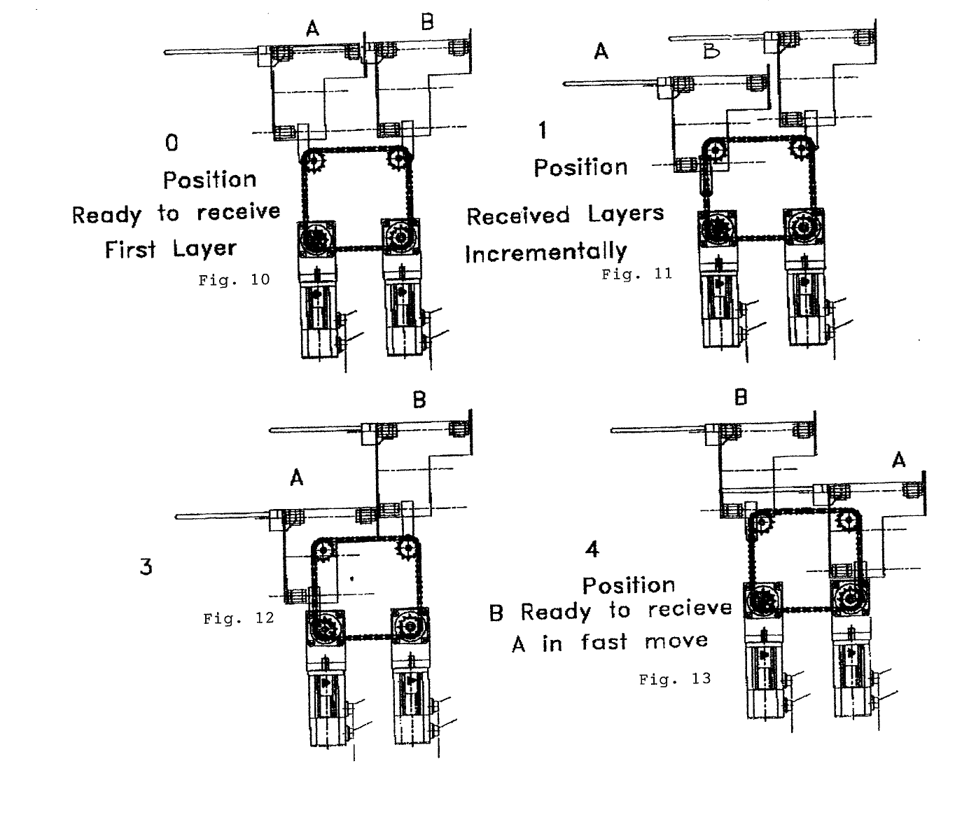

Platforms A and B are so constructed and arranged as to be initially presented in the fully elevated position as shown in FIG. 10. Each time a subsequent group and carrier member are deposited, the designated elevator platform (A in FIGS. 10-13) will be lowered a distance equal to the thickness of a group and carrier member in precise increments until a predetermined number of groups of articles, each of which is supported by a carrier member, has been vertically stacked. At that time platform A has reached the position shown in FIG. 12. After a predetermined number of groups of articles have been stacked, platform A has reached the position shown in FIG. 11. It is then, by the action of a servo motor, quickly moved downwardly to a location for depositing the entire stack of carrier member-carried groups onto the out feed conveyor 71, the function of which is to advance the stack of articles from beneath the zone of vertical travel of platform A to a location where it is deposited by a quick withdrawal of platform A horizontally. An inverted carton may be lowered onto the group stack for packaging. The now-filled carton is turned enabling the side and end flaps to be activated to house the articles within the carton. The package is then ready for refrigeration, storage or delivery to a purchaser.

In the preferred embodiment of the invention, elevator assembly 64 comprises a left operative section designated platform A and a right operative section designated platform B which are identical in structure and motion, both of the sections being suitably counter balanced. When the left section of elevator assembly 64 is up with platform A elevated and extending outwardly to accept a sequence of group-laden carrier members, platform B of the right section is located in a fully elevated but inoperative position, having been elevated from its lower most retracted to its fully raised, but inoperative position. In this position platform B is poised for rapid movement to the left. The advance of platform B occurs simultaneously with the retraction of platform A and these steps are continued until the packaging operation has been completed.

The input speed of belt 42 and conveyor strands 36 is twice the speed of the highest number of product groups required per minute. The functions necessary to the present invention to control cycle time, settings to adjust for product thickness, group size and others are preferably supplied by a Human Machine Interface (“HMI”), a programmable controller. A very satisfactory unit for the present invention is produced by CTC Parker Automation of Milford, Ohio.

Although one or more embodiments of the present invention have been shown and described, it will be obvious to those skilled in the art that the details of construction of these particular embodiments may be modified without departing from the concept presented. It is, therefore, intended that the invention be limited only by the scope of the appended claims rather than by particular details of construction shown.

What is claimed is:

1. Apparatus for accumulating in a vertical stacked relationship a predetermined number of groups of flat articles and thereafter relocating and releasing the entire stack for further processing comprising: means advancing a plurality of flat substantially similar articles in an end-to-end co-planar relationship along a continuous path of travel from an article source; means arranging a predetermined number of flat articles into individual article groups; means adjusting and controlling the movement and compaction of the individual article groups of flat articles; means selectively advancing each group of articles to a carrier means for movement to a group stacking location; means forming a stack of article groups at the group stacking location; and means removing the formed stacks of article groups from the group stacking location and depositing the formed stacks of article groups at a remote location for further processing.

2. The apparatus as claimed in claim 1 wherein the advancing means includes a plurality of conveyor strands supporting the plurality of flat substantially similar articles and groups formed therefrom.

3. The apparatus as claimed in claim 1 wherein the arranging means includes an initial lifting stage operable with the conveyor strands to form and define groups of articles of similar size.

4. The apparatus as claimed in claim 1 wherein the adjusting and controlling means includes one or more additional lifting stages operable with the conveyor strands to selectively terminate and initiate movement of groups of articles of similar size to prevent compression and compaction of the articles as they move along the continuous path of travel.

5. The apparatus as claimed in claim 1 where the selectively advancing means includes a stop/release mechanism for terminating and initiating movement of individual groups of articles in a timed sequence with a carrier means for movement to a group stacking location.

6. The apparatus as claimed in claim 1 wherein the stack forming means includes an elevator assembly.

7. The apparatus as claimed in claim 1 wherein the formed stack removing means includes one or more movable platforms to collect, transport and deposit the formed stacks at a remote location for further processing.

8. The apparatus as claimed in claim 2 wherein the arranging means includes an initial lifting stage operable with the conveyor strands to form and define groups of articles of similar size, the adjusting and controlling means includes one or more additional lifting stages operable with the conveyor strands to selectively terminate and initiate movement of groups of articles of similar size to prevent compression and compaction of the articles as they move along the continuous path of travel, the selectively advancing means includes a stop/release mechanism for terminating and initiating movement of individual groups of articles in a timed sequence with a carrier means for movement to a group stacking location, the stack forming means includes an elevator assembly and the formed stack removing means includes one or more movable platforms to collect, transport and deposit the formed stacks at a remote location for further processing.

9. The apparatus as claimed in claim 3 wherein the initial lifting stage has a plurality of rails interspersed between conveyor strands and selectively movable vertically to engage articles moving on the conveyor strands, elevate and maintain the articles in a stationary condition, and return the articles to the conveyor strands for continued movement.

10. The apparatus as claimed in claim 4 wherein the one or more lifting stages has a plurality of rails interspersed between conveyor strands and selectively movable vertically to engage articles moving on the conveyor strands, elevate and maintain the articles in a stationary condition, and return to the conveyor strands provide desirable article spacing and avoid article compression and compaction.

11. The apparatus as claimed in claim 5 wherein the stop/release mechanism is a paddle wheel programmed to engage and terminate movement of individual groups of articles and thereafter release and allow movement of the engaged group for sequenced placement on the carrier means.

12. The apparatus as claimed in claim 11 wherein the carrier means is a group supportable shuttle movable from the group engagement location to the group stacking location and back again.

13. The apparatus as claimed in claim 11 wherein the paddle wheel selectively repositions to a new formed stop position for the succeeding group when the current group is released for movement.

14. The apparatus as claimed in claim 9 wherein the conveyor strands and plurality of rails are configured to form one or more paths of travel and one or more additional lifting stages.

15. The apparatus as claimed in claim 14 further comprising: sensor means positioned adjacent the one or more lifting stages detecting the absence of articles as the articles move along the continuous path of travel and operable with the one or more lifting stages to provide replacement articles for the absent articles.

16. The apparatus as claimed in claim 8 wherein the initial lifting stage has a plurality of rails interspersed between conveyor strands and selectively movable vertically to engage articles moving on the conveyor strands, elevate and maintain the articles in a stationary condition, and return the articles to the conveyor strands for continued movement.

17. The apparatus as claimed in claim 16 wherein the one or more lifting stages has a plurality of rails interspersed between conveyor strands and selectively movably vertically to engage articles moving on the conveyor strands, elevate and maintain the articles in a stationary condition, and return the articles to the conveyor strands to provide desirable spacing and avoid article compression and compaction, the stop/release mechanism is a paddle wheel programmed to engage and terminate movement of individual groups of articles and thereafter release and allow movement of the engaged group for sequenced placement on the carrier means, the paddle wheel selectively repositions to a new formed stop position for the succeeding group when the current group is released for movement, and the carrier means is a group supportable shuttle movable from the group engagement location to to the group stacking location and back again.

18. A process for accumulating in a vertical stacked relationship a predetermined number of groups of flat articles and thereafter relocating and releasing the entire stack for further processing comprising the steps of: advancing a plurality of flat substantially similar articles in an end-to-end co-planar relationship along a continuous path of travel from an article source; arranging a predetermined number of flat articles into individual article groups; adjusting and controlling the movement and compaction of the individual article groups of flat articles; selectively advancing each group of articles to a carrier for movement to a group stacking location; forming a stack of article groups at the group stacking location; and removing the formed stacks of article groups from the group stacking location and depositing the formed stacks of article groups at a remote location for further processing.

19. The process as claimed in claim 18 wherein the articles are advanced on a plurality of conveyor strands, the groups are formed on a lifting stage, the groups are adjusted and controlled on one or more additional lifting stages, the groups are advanced by a stop/release mechanism, and the stack forming means is an elevator assembly, the formed stacks are removed a platform of the elevator assembly.
